(19) United States
(12) Patent Application Publication
(10) Pub. No.: US 2024/0176478 A1
(43) Pub. Date: May 30, 2024

(54) METHOD, DEVICE AND STORAGE MEDIUM FOR OBJECT DRAGGING

(71) Applicant: Beijing Bytedance Network Technology Co., Ltd., Beijing (CN)

(72) Inventors: Jing Li, Beijing (CN); Meiping Ren, Beijing (CN)

(21) Appl. No.: 18/435,973

(22) Filed: Feb. 7, 2024

Related U.S. Application Data
(63) Continuation of application No. PCT/CN2022/104338, filed on Jul. 7, 2022.

(30) Foreign Application Priority Data
Aug. 20, 2021 (CN) 202110957816.3

(51) Int. Cl. G06F 3/0486; G06F 3/04817; G06F 9/451; G06F 9/54

(52) U.S. Cl. CPC G06F 3/0486; G06F 3/04817; G06F 9/451; G06F 9/543

(57) ABSTRACT

Methods, devices and storage media are provided for object dragging implemented at an electronic device. One of the methods includes establishing a connection between a first operating system and a second operating system; in response to a drag operation by a user on a target object in a first application in the first operating system, obtaining position information corresponding to the drag operation; in accordance with a determination that an application window corresponding to the position information belongs to a window of a second application in the second operating system, and that a drag release operation by the user on the target object is received, controlling the first application to send drag data of the target object to the second application; and performing, based on the drag data, a target operation on the target object in the second application.

### CROSS-REFERENCE TO RELATED APPLICATIONS

This application is a continuation application of, and claims priority to PCT application PCT/CN2022/104338, filed on Jul. 7, 2022, which claims priority to Chinese Patent Application No. 202110957816.3, filed on Aug. 20, 2021. The disclosure of the foregoing applications are incorporated here by reference.

### BACKGROUND

### Field

Embodiments of the present disclosure relate to the field of computer technologies, for example, a method, device and storage medium for object dragging.

### Background

With the development of computer technologies, in order to expand applications (APPs) under a Linux® system and enrich the application environments, the Linux® system can support applications of an Android® system to run.

In the related art, one technique used by the Linux® system to support Android® is to use a virtual machine, and another technique is to use a scheme, such as Anbox or xDroid. Regardless of particular technique used, when a content (such as text, an image or a file, etc.) is transferred between an APP in the Linux® system and an APP in the Android® system, importing of the content can typically only be implemented in a copy mode from the Linux® system to the Android® system generally.

### SUMMARY

The embodiments of the present disclosure provide a method, device and storage medium for object dragging, which enables content transfer between APPs across systems, and is easy to operate.

The embodiments of the present disclosure provide a method for object dragging. The method is implemented at an electronic device with a first operating system and a second operating system running. The second operating system runs in the first operating system in a containerized mode. The first operating system comprises a first application, and the second operating system comprises a second application.

In the method, the electronic device establishes a connection between the first operating system and the second operating system.

In response to a drag operation by a user on a target object in the first application, the electronic device obtains position information corresponding to the drag operation.

In accordance with a determination that an application window corresponding to the position information belongs to a window of the second application in the second operating system, and that a drag release operation by the user on the target object is received, the electronic device controls the first application to send drag data of the target object to the second application.

The electronic device performs, based on the drag data, a target operation on the target object in the second application.

The embodiments of the present disclosure further provide an apparatus for object dragging. The apparatus is implemented at an electronic device with a first operating system and a second operating system running. The second operating system runs in the first operating system in a containerized mode. The first operating system comprises a first application, and the second operating system comprises a second application. The apparatus for object dragging comprises a processing module and an obtaining module.

The processing module is configured to establish a connection between the first operating system and the second operating system.

The obtaining module is configured to, in response to a drag operation by a user on a target object in the first application, obtain position information corresponding to the drag operation.

The processing module is further configured to, in accordance with a determination that an application window corresponding to the position information belongs to a window of the second application in the second operating system, and that a drag release operation by the user on the target object is received, control the first application to send drag data of the target object to the second application.

The processing module is further configured to perform, based on the drag data, a target operation on the target object in the second application.

The embodiments of the present disclosure further provide an electronic device comprising a memory, a processor, and a computer program that is stored on the memory and executable on the processor. The program, when executed by the processor, performs operations that implement the steps of any of the above-described methods for object dragging.

The embodiments of the present disclosure further provide a non-transitory computer readable storage medium having a computer program stored thereon. The computer program, when executed by a processor, performs operations that implement the steps of any of the above-described methods for object dragging.

The embodiments of the present disclosure further provide a computer program product comprising a computer program. The computer program, when executed by a processor, performs operations that implement the steps of any of the above-described methods for object dragging.

### BRIEF DESCRIPTION OF DRAWINGS

The following will be a brief introduction to the embodiments, or the accompanying drawings required for the description of related techniques. The accompanying drawings in the following description are some embodiments of the present disclosure. For those skilled in the art, other drawings can also be obtained based on these drawings, without creative labor premise.

FIG. 1 is a schematic flowchart of an embodiment of a method for object dragging provided in the embodiments of the present disclosure.

FIG. 2 is a schematic diagram of a display interface provided in the embodiments of the present disclosure.

FIG. 3a is a schematic diagram of a display interface provided in the embodiments of the present disclosure.

FIG. 3b is a schematic diagram of a display interface provided in the embodiments of the present disclosure.

FIG. 3c is a schematic diagram of display interface provided in the embodiments of the present disclosure.

FIG. 4 is a schematic diagram of display interfaces provided in the embodiments of the present disclosure.

FIG. 5 is a schematic diagram of a flow of internal interactions within an electronic device provided in the embodiments of the present disclosure.

FIG. 6 is a schematic diagram of a flow of internal interactions within an electronic device provided in the embodiments of the present disclosure.

FIG. 7 is a schematic diagram of a flow of internal interactions within an electronic device provided in the embodiments of the present disclosure.

FIG. 8 is a diagram of a structure of an apparatus for object dragging provided in the present disclosure.

FIG. 9 is a diagram of a structure of an electronic device provided in the embodiments of the present disclosure.

### DETAILED DESCRIPTION

The following will provide a description of the technical solution provided in the embodiments of the present disclosure, in conjunction with the drawings in the embodiments of the present disclosure. The described embodiments are only part of the embodiments of the present disclosure, not all embodiments. Based on the embodiments in the present disclosure, all other embodiments obtained by those skilled in the art without creative labor are within the scope of protection of the present disclosure.

First, some of the vocabularies and application scenarios related to the embodiments of the present disclosure will be introduced.

The method of the embodiments of the present disclosure can be implemented at an electronic device. In one embodiment, the electronic device is provided with at least two systems, such as a first operating system and a second operating system. The second operating system runs in the first operating system in a containerized mode. As those skilled in the art, containerization is a Linux® software container (Linux® Container, LXC) implemented based on a Linux® kernel characteristic, which makes full use of Cgroup and Namespace characteristics, to isolate a process and a resource, so that the second operating system can be implemented in an efficient and lightweight mode.

In the embodiments of the present disclosure, although not explicitly described, the first operating system and the second operating system may be the same, for example, the first operating system and the second operating system are Linux® or Android®. The first operating system and the second operating system may be different, for example, the first operating system and the second operating system are Linux® for one and Android® for another.

In the embodiments of the present disclosure, the application refers to an application having one or more functions in an operating system, such as a file manager, image viewer, music player, video player and the like. Data dragging between applications across systems refers to dragging a target object in a first application directly into an interface of a second application without importing the target object into the second operating system in a copy mode firstly and then opening the target object with the second operating system. For example, the first application is a file manager, the target object is an image, and the second application is an image viewer. The image in a file manager interface in the first operating system is dragged and dropped to the image viewer in the second operating system for image display.

In related technologies, the content transfer across systems usually selects and copies the target object in the file manager interface in the first operating system, pastes the target object in the file manager interface of the second operating system, and then opens it with an application corresponding to the target object.

The method provided in the embodiments of the present disclosure may be implemented by an electronic device executing corresponding software code as a processor or may be implemented through data interaction with a server while the electronic device is executing the corresponding software code.

The technical concept of the method for object dragging in the embodiments of the present disclosure is as follows:

A user performs a drag operation on a target object in a first operating system. This is processed internally in an electronic device. In accordance with a determination that the target object is moved to a window of an application in the second operating system and that a drag release operation by the user and a drag end instruction is received, a target operation is directly performed on the target object in the application in the second operating system, such as displaying or playing the target object in the application of the second operating system, which realizes object transfer across systems and makes a user operation simpler and more intuitive.

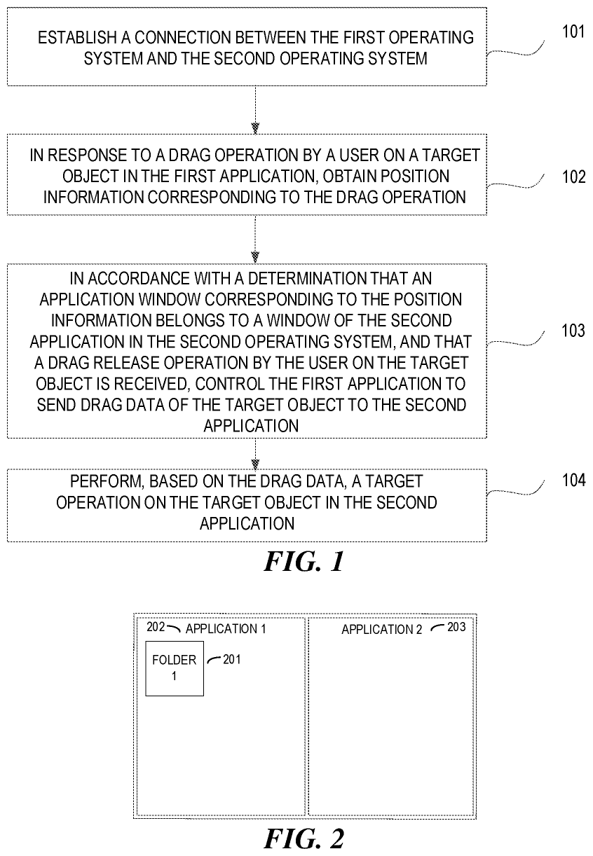

In conjunction with FIGS. 1-7, the technical solution of the embodiments of the present disclosure are described below. The following embodiments may be combined with each other, for which the same or similar concepts or processes may not be repeated in some embodiments.

FIG. 1 a schematic flowchart of an embodiment of a method for object dragging provided in the embodiments of the present disclosure. As shown in FIG. 1, the method provided by the present embodiment is implemented on an electronic device with a first operating system and a second operating system running. The second operating system runs in the first operating system in a containerized mode. The first operating system comprises a first application, and the second operating system comprises a second application. The method includes the following Step 101, Step 102, Step 103 and Step 104.

In Step 101, the electronic device establishes a connection between the first operating system and the second operating system.

In Step 102, in response to a drag operation by a user on a target object in the first application, the electronic device obtains position information corresponding to the drag operation.

It can be understood that in order to achieve data interaction between the first operating system and the second operating system, the first operating system and the second operating system need to establish the connection.

The drag operation is performed by the user on the target object in the first application. In response to the drag operation, the electronic device obtains the position information corresponding to the drag operation. The drag operation is a continuous process. As the user moves the target object, a position of the target object will change. The position information comprises, for example, a position coordinate of the target object in a display interface of the electronic device, and the position coordinates can be obtained continuously through a window manager in the system.

For example, the drag operation can be implemented through an input device (such as a mouse, a keyboard, etc.) connected to the electronic device, or user operations on a touch screen of the electronic device.

In some examples, the target object comprises a file, a folder, an image, a video (such as an image or a video being displayed), music, or text, etc.

For example, the user clicks on the target object on the display screen and performs a sliding operation.

As shown in FIG. 2, a display interface of an electronic device is shown, and Application 1 202 and Application 2 203 are applications in a first and second operating systems, respectively. Folder 1 201 is displayed in a window of Application 1 202.

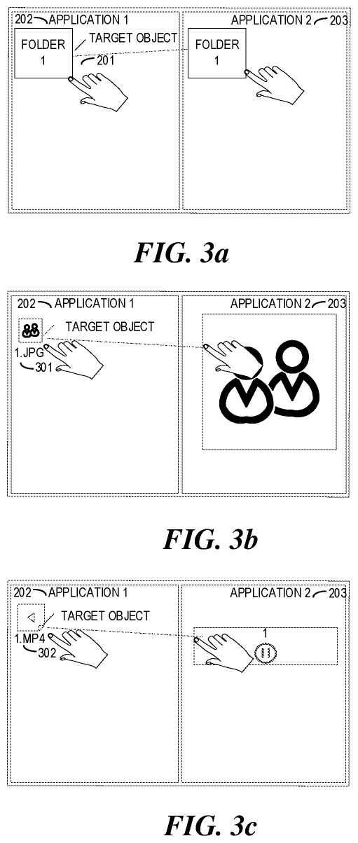

If a user wants to drag Folder 1 201 into Application 2 203, as shown in FIG. 3, the user clicks an icon of Folder 1 201 with his/her finger or mouse and drags the icon of Folder 1 201 into a window of Application 2 203. In response to the drag operation by the user on Folder 1 201 in Application 1 202, the electronic device obtains position information corresponding to the drag operation, that is, the position information of Folder 1 201 during movement.

In one embodiment, the connection between the first operating system and the second operating system comprises a socket interface Socket connection.

In Step 103, in accordance with a determination that an application window corresponding to the position information belongs to a window of the second application in the second operating system, and that a drag release operation by the user on the target object is received, the electronic device controls the first application to send drag data of the target object to the second application.

In one embodiment, if the user moves the target object to the window of the second application in the second operating system, and the user performs the drag release operation, for example, the user raises the pressed finger or mouse button, the drag process is thereby completed.

For example, the drag release operation can be implemented through an input device (such as a mouse, a keyboard, etc.) connected to the electronic device, or user operations on a touch screen of the electronic device.

After the electronic device receives an instruction of drag completion, that is, after the drag release operation is received, the drag data of the target object is sent to the second application. The second application cannot perform the target operation on the target object in the second application until the drag data of the target object is obtained.

As shown in FIG. 3a, Folder 1 201 is displayed in Application 2 203, that is, the icon of Folder 1 is displayed in the display window of Application 2 203.

It is possible to distinguish which operating system's application corresponds to a current position based on a window property provided by a window manager.

For example, the window manager can determine the window property based on information of the first and second applications to distinguish which operating system's application corresponds to the current position.

In Step 104, the electronic device performs, based on the drag data, a target operation on the target object in the window corresponding to the second application.

In some examples, after obtaining the drag data, the second application performs, based on the drag data, a target operation on the target object in the window corresponding to the second application. The drag data may comprise content data of the target object, a window identification or a storage path of the second application, etc. For example, the drag data may also comprise an icon style and size of the target object and the like. The target operation may comprise at least one of storage, display, playback, searching for an address in a map application and displaying, etc.

For example, as shown in FIG. 3a, the icon of Folder 1 201 is displayed in the window of Application 2 203.

In FIG. 3a, the user moves the position of the target object on the display interface of the electronic device. During the movement of the target object by the user, the windows displayed by the first application and the second application are not affected. The operation is relatively simpler and more intuitive.

For example, a piece of text, such as an address, is dragged from Application 1 202 to display a location of the address in the window of Application 2 203, which is a map application.

As shown in FIG. 3b, an image file 301 is dragged from Application 1 202 to display the image in the window of Application 2 203, which, for example, is an image viewer. If Application 2 203 is a file manager, it is directly saved in Application 2 203, and the icon of the image file 301 is displayed in the window of Application 2 203, as shown on the left in FIG. 3b.

As shown in FIG. 3c, a music file 302 is dragged from Application 1 202 to play the music file in the window of Application 2 203, which, for example, is a music player. A play icon is displayed in the window of Application 2 203.

In one embodiment, in the method for object dragging provided in the embodiments of the present disclosure, when the user performs the drag operation on the target object in the first application in the first operating system, in response to the drag operation by the user, the position information corresponding to the drag operation is obtained. Whether the position that the target object is located belongs to a window of the second application in the second operating system is determined based on the position information. In accordance with a determination that it belongs to a window of the second application in the second operating system, and that a drag release operation by the user on the target object is received, the first application is controlled to send drag data of the target object to the second application. In such a way, the second application obtains the drag data of the target object. Then the second application performs, based on the drag data, the target operation on the target object in the second application, which enables the object transfer between applications in different systems. The user only performs the drag operation and the drag release operation, and the operation is relatively simpler.

In the method of the embodiments, the user performs the drag operation on the target object, and the electronic device determines the position of the target object internally. In accordance with a determination that the target object is moved to the application window of other systems, and that the drag and release operation by the user is received, i.e., a drag end instruction, the target operation is performed directly on the target object in the application in other systems, to enable object transfer across systems and simplify the user operation.

In one embodiment, step 104 may be implemented as follows. The electronic device controls the second application to obtain the target object based on the drag data. The electronic device performs the target operation on the target object in the second application, or the electronic device performs, based on a content of the target object from the drag data, the target operation on the target object in the second application.

Alternatively, the drag data may comprise corresponding data of the target object, such as content, a storage path, or metadata of the target object. For example, the metadata may comprise data type information, and the drag data may further comprise relevant information of a target application (i.e., the second application). In some embodiments, if the content of the target object is not included in the drag data, the target object can be obtained based on other information in the drag data. For example, the target object is an image, and if the content of the image is not included in the drag data, for example, the storage address of the image is included in the drag data, the target object, that is, the image, can be obtained based on the storage address. In turn, the target operation can be performed on the target object in the second application based on the obtained target object.

If the content of the target object is included in the drag data, the target operation is directly performed on the target object in the second application.

In some examples, in the method, after step 104: the electronic device presents a target icon in a window corresponding to the second application based on a window identifier of the second application comprised in the drag data. The target icon is generated based on the drag data.

In one embodiment, the window corresponding to the second application is determined based on the window identifier of the second application comprised in the drag data. The target icon is displayed in the window corresponding to the second application. As shown in FIG. 3a, the icon of the folder is displayed (i.e., the same as the icon displayed in the first application). As shown in FIG. 3c, the icon of the playback control is displayed. Alternatively or in addition, for example, an icon for identifying the location of some address can also be displayed in the map application.

In the above embodiment, the user performs the drag operation on the target object. The electronic device determines the position of the target object internally. In accordance with a determination that the target object is moved to the application window of other systems, and that the drag and release operation by the user is received, i.e., a drag end instruction, the second application is controlled to obtain the target object based on the drag data. The target icon is displayed in the window corresponding to the second application based on the window identifier of the second application comprised in the drag data. In such a way, it is possible to enable object transfer across systems, simplifies the user operation and is more intuitive.

In other implementations, obtaining the target object can be achieved in the following ways.

For example, the drag data comprises a storage path of the target object, and the second application is controlled to obtain the target object based on the storage path.

It will be appreciated that, in order to reduce the amount of data transmitted and improve transmission efficiency, the drag data may also comprise the storage path of the target object, and the second application may obtain the target object directly from the storage path.

For example, if the target object is a file, the storage path can be carried by the file descriptor of the file. After receiving the file descriptor, the second application directly reads the file content, which can improve transmission efficiency.

In the above embodiment, the storage path obtaining the target object, the transmission efficiency can be improved.

For example, the drag data comprises an access identifier of a shared memory occupied by the target object. The second application is controlled to obtain the target object from the shared memory based on the access identifier of the target object.

In one embodiment, the drag data may comprise the access identifier of the shared memory occupied by the target object. The second application is controlled to obtain the target object from the shared memory based on the access identifier of the shared memory occupied by the target object.

In the above implementation, the content transfer is achieved by sending the file descriptor of the target object, and the transmission efficiency is higher.

For example, in accordance with a determination that the drag data comprises the file descriptor of the target object, the second application is controlled to obtain the target object based on the file descriptor.

In one embodiment, the drag data may comprise the file descriptor of the target object. For example, if the target object is a file, before the drag operation is performed on the target object, the target object is opened in the kernel. The kernel returns the corresponding file descriptor. At this time the memory is not occupied. The file descriptor is transferred to the second application, and the second application obtains the content of the target object based on the file descriptor.

In the above implementation, content transfer is achieved by sending the access identifier of the shared memory occupied by the target object, and the transmission efficiency is higher.

In one embodiment, in accordance with a determination that a content of the target object is carried by a memory copy, before obtaining the target object, the electronic device further reads the content of the target object into a memory. Optionally, in the case that the content of the target object is carried by the memory copy, before sending the drag data of the target object to the second application, further comprising reading the contents of the target object into the memory.

It can be understood that in order to achieve efficient transmission display, the content of the target object can be carried by the memory copy. Before sending the drag data of the target object to the second application, the content of the target object can be read into memory, and then the memory copy is directly sent to the second application. The memory copy carries the content of the target object.

In the above implementation, the content transfer is achieved by sending the content of the target object. In addition, efficiency can be improved by reading into memory.

In one embodiment, the drag data further comprises: position information of the target object in the window corresponding to the second application. Based on the window identifier, the target icon is presented in the window corresponding to the second application. This may be achieved in the following manner: determining the second application corresponding to the window identifier; and presenting the target icon in the window corresponding to the second application based on the position information of the target object in the window corresponding to the second application.

For example, the second application is determined first where the moved target object is located. That is, the second application corresponding to the window identifier is determined. The target icon is then displayed in the window corresponding to the second application based on the position information of the target object in the window corresponding to the second application. The position of the target object when the drag release operation by the user is received.

As shown in FIG. 3a, if the user's finger is raised in the upper left corner of Application 2 203, the position of Folder 1 201 in the window corresponding to Application 2 203 is the upper left corner, that is, the icon of Folder 1 201 is presented in the upper left corner of the window corresponding to Application 2 203.

In one embodiment, prior to step 102, the following operations may also be performed. The electronic device determines, based on a window state of the second application, whether the window of the second application is in an active state. In accordance with a determination that the window of the second application is in the active state, the electronic device performs the operation of step 102.

For example, before sending data to the second application, it can be determined whether the window state of the second application is active or inactive. If it is in the active state, subsequent operations can be performed. If it is in the inactive state, the window of the second application can be activated first, and then step 102 can be performed.

In other embodiments, when the operation of step 102 is performed, the window of the second application may be in the inactive state.

In one embodiment, in the method for object dragging, in response to the drag operation by the user on the target object in the first application, the electronic device presents a drag effect view. The drag effect view includes at least one of a highlight effect, a shadow effect, a blur effect, and an overlap effect for the target object.

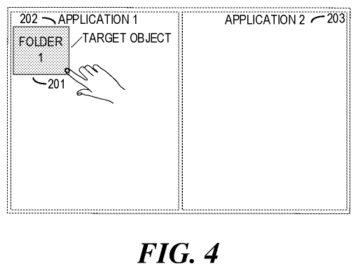

As shown in FIG. 4, the application windows of two operating systems are shown. Application 1 202 represents the application window of the first operating system, and Application 2 203 represents the application window of the second operating system. FIG. 4 shows the drag effect generated after the user's finger selects the target object to be dragged. A highlighted effect, for example, is represented in FIG. 4.

In the above implementation, when the user is dragging the target object in the first application, the drag effect can be presented on a display interface, such as the highlighting effect, shadow effect, blurring effect, and overlapping effect, which is more intuitive. The user can clearly see that the target object has been selected, and the user experience is improved.

In one embodiment, prior to step 104, in the method, the electronic device may further determine whether the target object matches the second application based on the metadata of the target object. In accordance with a determination that the target object matches the second application, the electronic device may perform the operation of step 104.

The metadata of the target object (metadata), for example, comprises data type information, such as text, an image or a file. For example, when dragging an image from a Linux® image manager to an Android® music playback application, the electronic device will determine whether it is matched based on the data type information of the target object. Based on the determination result that it is not matched, the music playback application is controlled to stop performing the drag event.

In one embodiment, a drag operation and a drag release operation on the target object is achieved by dragging (drag) event and drag release (drop) event. There is the metadata of the target object (comprising the data type information) in the drag event to distinguish the data type of the target object (text or image or file, etc.). When performing the drop event, the interface of the second application will obtain an imported parameter for the operation of the drag event by which the operation corresponding to the drop event is determined. When the data type information of the target object carried in the drag event does not match Application 2 of the second operating system, for example, dragging an image from the Linux® image manager to the Android® music playback application, the music playback application will determine to discard the drag event based on the data type information in the drag event.

In the above implementation, by determining whether the target object matches the second application, if it does not match, no subsequent operations need to be performed, which can save the operation process of the device and avoid unnecessary operations.

In one embodiment, the first operating system includes a first window manager. The second operating system includes a second window manager. After receiving the drag operation on the target object by the user, the electronic device further controls the first window manager to send a drag request to the second window manager. The drag request includes metadata of the target object and a window identifier of the second application of the second operating system.

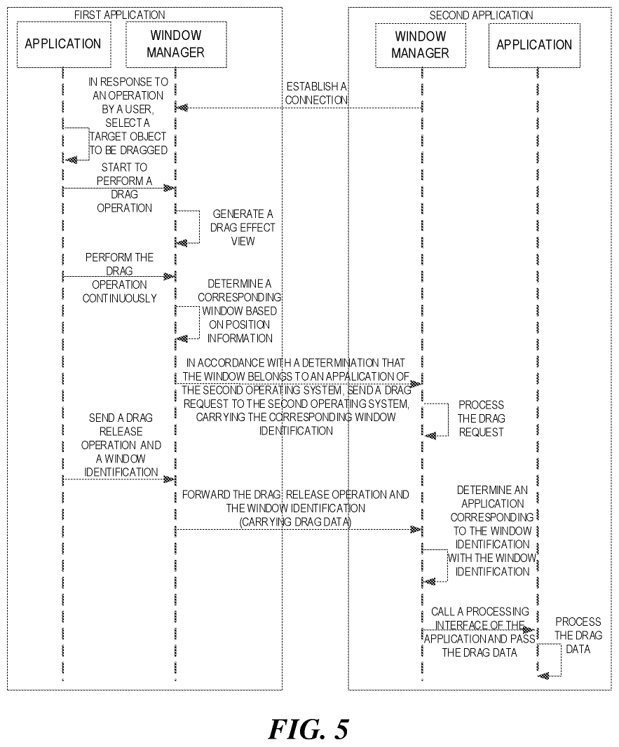

As shown in FIG. 5, the first operating system comprises a first window manager, and the second operating system comprises a second window manager. The electronic device can achieve interaction between the first operating system and the second operating system through the socket connection between the first window manager and the second window manager. After receiving the drag operation by the user on the target object, the first window manager sends the drag request to the second window manager, and the second window manager sends a drag request to the second application based on the window identifier comprised in the drag request. That is, the second window manager searches the corresponding second application based on the window identifier and sends the drag request to the second application.

For example, the window manager can call a processing interface of the second application (such as a drag response interface), and then pass the drag data of the target object as a parameter to the second application. The subsequent processing flow is determined by the second application.

The second application can further determine whether the target object matches the second application based on the data type information included in the metadata of the target object. If the target object does not match the second application, it is discarded. If the target object matches the second application, subsequent processing is performed.

In one embodiment, step 103 may be implemented as follows. The electronic device controls the first window manager to send the drag data to the second window manager. The electronic device controls the second window manager to send the drag data to the second application based on a window identifier included in the drag data.

As shown in FIG. 5, the first operating system comprises a first window manager. The second operating system comprises a second window manager. The electronic device can send data of the first operating system to the second operating system through the interaction between the first window manager and the second window manager. The first window manager sends the drag data to the second window manager. The second window manager sends the drag data to the second application based on the window identifier included in the drag data. That is, the second window manager searches the corresponding second application based on the window identifier ID and sends the drag data to the second application.

In one embodiment, the first operating system includes a first window manager and a first service proxy component. The second operating system includes a second window manager and a second service proxy component. A socket connection is established between the first service proxy component and the second service proxy component. The drag request may be sent in the following manner: controlling the first window manager to send the drag request to the first service proxy component; controlling the first service proxy component to send the drag request to the second service proxy component; and controlling the second service proxy component to send the drag request to the second window manager.

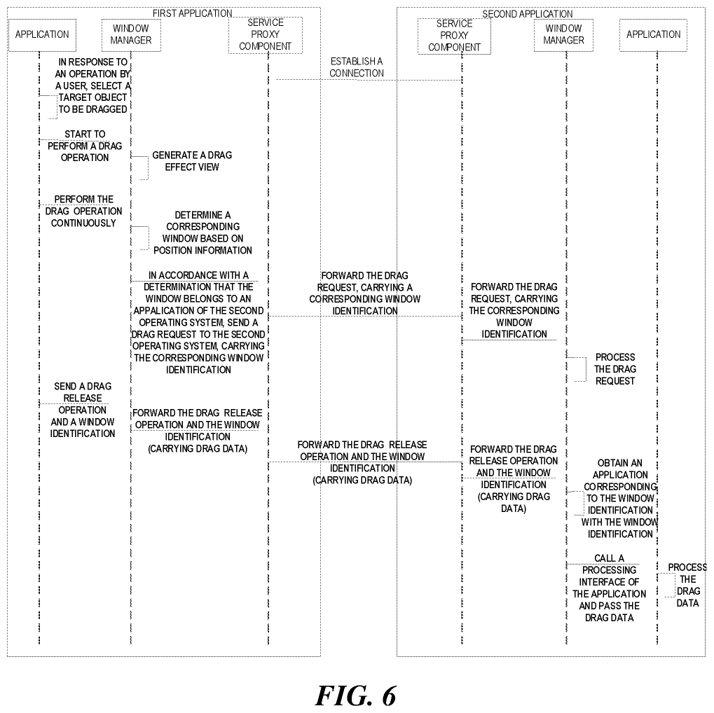

As shown in FIG. 6, the first operating system includes a first window manager and a first service proxy component. The second operating system includes a second window manager and a second service proxy component. The electronic device can achieve data exchange between the first operating system and the second operating system through the interaction between the first window manager, the first service proxy component, the second service proxy component, and the second window manager. The first window manager sends a drag request to the first service proxy component. The first service proxy component sends the drag request to the second service proxy component, and the second service proxy component sends the drag request to the second window manager. The second window manager sends the drag request to the second application based on the window identifier included in the drag request. That is, the second window manager searches the corresponding second application based on the window identifier and sends the drag request to the second application.

In one embodiment, controlling the first window manager to send the drag data to the second window manager comprises: controlling the first window manager to send the drag data to the first service proxy component; controlling the first service proxy component to send the drag data to the second service proxy component; controlling the second service proxy component to send the drag data to the second window manager; and controlling the second window manager to send the drag data to the second application based on a window identifier comprised in the drag data.

As shown in FIG. 6, the first operating system comprises a first window manager and a first service proxy component, and the second operating system comprises a second window manager and a second service proxy component. The electronic device can send data from the first operating system to the second operating system through the interaction between the first window manager, the first service proxy component, the second service proxy component, and the second window manager. The first window manager sends drag data to the first service proxy component. The first service proxy component sends drag data to the second service proxy component, and the second service proxy component sends drag data to the second window manager. The second window manager sends the drag data to the second application based on the window identifier ID included in the drag data. That is, the second window manager searches the corresponding second application based on the window identifier and sends the drag data to the second application.

In the above implementation, the content transfer between applications across different systems is realized through the interaction between the first operating system and the second operating system inside the electronic device, that is, the interaction between the first application of the first operating system, the first window manager, the first service proxy component, the second service proxy component, the second window manager, and the second application. The implementation process is simple, the user operation is simple, and the drag process is more intuitive.

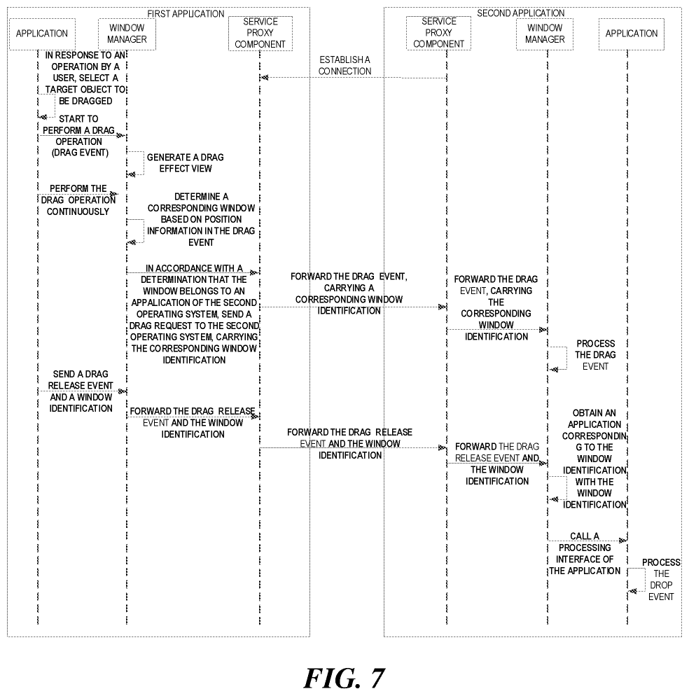

FIG. 7 shows the transfer of the target object from the first application to the second application. The first application, for example, is an application on the Linux®, and the second application, for example, is an Android® application. In this embodiment, for example, the drag process can be achieved by a drag event, drop event.

In one embodiment, the drag event refers to the drag operation on the target object. There is the metadata of the target object (comprising data type information) in the drag event to distinguish the data type of the drag (text or image or file). When the drop event is performed (a placement operation on the target object), the interface of the second application obtains the imported parameter of the drag event operation and determines the operation corresponding to the drop event based on this. When the data type carried by the drag event does not match the second application, for example, dragging an image from the Linux® image manager to the Android® music playback application, the music playback application will discard the drag event based on the information in the drag event.

Steps in FIG. 7 are similar to those of FIGS. 5 and 6, the implementation principle of which refers to the embodiments of FIG. 5 and FIG. 6, not described herein again.

For example, before forwarding the drag event, it is first determined whether the state of the corresponding window is the active state or the inactive state. Subsequent operations can be performed on the active window or the inactive window. During the drag event, the current application can be determined as an Android® application, or a Linux® application based on the window properties given by the window manager.

The “forwarding” operation of each step in FIG. 7 can be achieved through a socket connection.

An apparatus for object dragging provided by embodiments of the present disclosure will be described in following, the apparatus for object dragging described below may correspond to each other with reference to the method for object dragging described above.

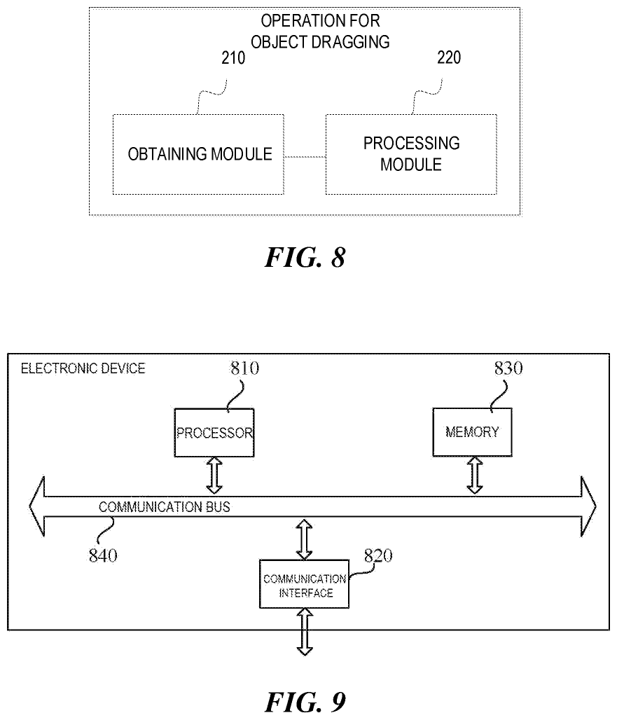

FIG. 8 is a schematic diagram of the structure of the apparatus for object dragging provided in the present disclosure. The apparatus for object dragging provided in the embodiments of the present disclosure is implemented at an electronic device with a first operating system and a second operating system running. The second operating system runs in the first operating system in a containerized mode. The first operating system includes a first application, and the second operating system includes a second application. The apparatus for object dragging comprises a processing module 220 and an obtaining module 210. The processing module 220 is configured to establish a connection between the first operating system and the second operating system. The obtaining module 210 is configured to, in response to a drag operation by a user on a target object in the first application, obtain position information corresponding to the drag operation. The processing module 220 is configured to, in accordance with a determination that an application window corresponding to the position information belongs to a window of the second application in the second operating system, and that a drag release operation by the user on the target object is received, control the first application to send drag data of the target object to the second application. The processing module 220 is further configured to perform, based on the drag data, a target operation on the target object in the second application.

In some examples, the processing module 220 is configured to control the second application to obtain the target object based on the drag data. The processing module 220 is configured to perform the target operation on the target object in the second application. Alternatively or in addition, the processing module 220 is configured to perform, based on a content of the target object included in the drag data, the target operation on the target object in the second application.

The apparatus further comprises a display module. The display module is configured to present a target icon in a window corresponding to the second application based on a window identifier of the second application comprised in the drag data. The target icon is generated based on the drag data.

In some examples, the processing module 220 is configured to, in accordance with a determination that the drag data comprises a storage path of the target object, control the second application to obtain the target object based on the storage path. Alternatively or in addition, the processing module 220 is configured to, in accordance with a determination that the drag data comprises an access identifier of a shared memory occupied by the target object, control the second application to obtain the target object from the shared memory based on the access identifier. Alternatively or in addition, the processing module 220 is configured to, in accordance with a determination that the drag data comprises a file descriptor of the target object, control the second application to obtain the target object based on the file descriptor.

In some examples, the first operating system comprises a first window manager, and the second operating system comprises a second window manager. The processing module 220 is configured to control the first window manager to send the drag data to the second window manager; and control the second window manager to send the drag data to the second application based on a window identifier included in the drag data.

In some examples, the first operating system includes a first window manager and a first service proxy component. The second operating system includes a second window manager and a second service proxy component. The processing module 220 is further configured to establish a connection between the first service proxy component and the second service proxy component. The processing module 220 is configured to control the first window manager to send the drag data to the first service proxy component. The processing module 220 is configured to control the first service proxy component to send the drag data to the second service proxy component. The processing module 220 is configured to control the second service proxy component to send the drag data to the second window manager. The processing module 220 is configured to control the second window manager to send the drag data to the second application based on a window identifier included in the drag data.

In some examples, the processing module 220 is further configured to, in accordance with a determination that a content of the target object is carried by a memory copy, before obtaining the target object, read the content of the target object into a memory.

In some examples, the drag data further comprises position information of an icon of the target object in the window corresponding to the second application. The processing module 220 is configured to determine the second application corresponding to the window identifier. The processing module 220 is configured to present the target icon in the window corresponding to the second application based on the position information of the target object in the window corresponding to the second application

In some examples, the processing module 220 is configured to: determine, based on a window state of the second application, whether the window of the second application is in an active state. The processing module 220 is configured to, in accordance with a determination that the window of the second application is in the active state, perform an operation of controlling the first application to send the drag data of the target object to the second application.

In some examples, the processing module 220 is further configured to, in response to the drag operation by the user on the target object in the first application, present a drag effect view. The drag effect view includes at least one of a highlight effect, a shadow effect, a blur effect, and an overlap effect for the target object.

In some examples, the processing module 220 is further configured to control the first window manager to send a drag request to the second window manager. The drag request includes metadata of the target object and a window identifier of the second application of the second operating system.

In some examples, the processing module 220 is further configured to determine whether the target object matches the second application based on the metadata of the target object. The processing module 220 is further configured to, in accordance with a determination that the target object matches the second application, perform a target operation on the target object in the second application based on the drag data.

The apparatus in the embodiment of the present disclosure is used to perform any of the foregoing embodiments, the implementation principle and technical effects of which are similar to those of the method, not described herein again.

FIG. 9 illustrates a schematic diagram of an entity structure of an electronic device. As shown in FIG. 9, the electronic device may comprise: a processor 810, a communication interface 820, a memory 830, and a communication bus 840, wherein the processor 810, the communication interface 820, and the memory 830 communicate with each other through the communication bus 840. The processor 810 can call logical instructions in the memory 830 to perform a method for object dragging. In the method, the processor 810 establishes a connection between the first operating system and the second operating system. In response to a drag operation by a user on a target object in the first application, the processor 810 obtains position information corresponding to the drag operation. In accordance with a determination that an application window corresponding to the position information belongs to a window of the second application in the second operating system, and that a drag release operation by the user on the target object is received, the processor 810 controls the first application to send drag data of the target object to the second application. The processor 810 performs, based on the drag data, a target operation on the target object in the second application.

In the above embodiment, there is a first operating system and a second operating system running on the electronic device. The second operating system runs in the first operating system in a containerized mode. The first operating system includes a first application, and the second operating system includes a second application.

In addition, the logical instructions in the memory 830 can be implemented in the form of software functional units and can be stored in a computer-readable storage medium when sold or used as an independent product. Based on this understanding, the technical solution of the present disclosure essentially or the part that contributes to the relevant technology or the part of the technical solution can be embodied in the form of a software product. The computer software product is stored in a storage medium, comprising at least one instruction for causing a computer device (which can be a personal computer, server, or network device, etc.) to perform all or part of the steps of the methods described in various embodiments of the present disclosure. The aforementioned storage media comprise U disk, mobile hard disk, Read-Only Memory (ROM), Random Access Memory (RAM), magnetic disk or optical disk and other media that can store program code.

On the other hand, embodiments of the present disclosure also provide a computer program product. The computer program product includes a computer program stored on a non-transitory computer-readable storage medium. The computer program includes program instructions. When the program instructions are executed by a computer, the computer can perform the method for object dragging provided by the above methods. In the method, the computer establishes a connection between the first operating system and the second operating system. In response to a drag operation by a user on a target object in the first application, the computer obtains position information corresponding to the drag operation. In accordance with a determination that an application window corresponding to the position information belongs to a window of the second application in the second operating system, and that a drag release operation by the user on the target object is received, the computer controls the first application to send drag data of the target object to the second application. The computer performs, based on the drag data, a target operation on the target object in the second application.

Yet another aspect, embodiments of the present disclosure also provides a non-transitory computer-readable storage medium having a computer program stored thereon. The computer program, when executed by a processor, causes an electronic device to implement the above-described method for object dragging provided above. In the method, the electronic device establishes a connection between the first operating system and the second operating system. In response to a drag operation by a user on a target object in the first application, the electronic device obtains position information corresponding to the drag operation. In accordance with a determination that an application window corresponding to the position information belongs to a window of the second application in the second operating system, and that a drag release operation by the user on the target object is received, the electronic device controls the first application to send drag data of the target object to the second application. The electronic device performs, based on the drag data, a target operation on the target object in the second application.

Advantageous effects of the electronic device, program and storage medium in embodiments of the present disclosure, with reference to the analysis of the beneficial effects of the above methods, not described herein again.

Apparatus embodiments described above are merely illustrative, wherein the units described as separate components may or may not be physically separated, the components displayed as units may or may not be physical units, i.e., may be located in one place, or may be distributed to a plurality of network elements. Some or all of the modules may be selected according to actual needs to implement the embodiments of the present disclosure. Those of ordinary skill in the art without creative labor, i.e., can be understood and implemented.

Through the description of the above embodiments, those skilled in the art can clearly understand that each embodiment can be implemented by means of software plus a necessary universal hardware platform, of course, it can also be implemented by hardware. Based on this understanding, the above technical solution essentially or part that contributes to the relevant technology can be embodied in the form of a software product. The computer software product can be stored in a computer-readable storage medium, such as ROM, RAM, magnetic disk, optical disk, etc., and comprises several instructions for causing a computer device (which can be a personal computer, server, or network device, etc.) to execute certain parts of the various embodiments or embodiments.

What is claimed is:

1. A method for object dragging, the method comprising:
establishing, at an electronic device with a first operating system and a second operating system running, a connection between the first operating system and the second operating system, wherein the first operating system comprises a first application, and the second operating system comprises a second application;
in response to a drag operation by a user on a target object in the first application, obtaining position information corresponding to the drag operation;
in accordance with a determination that an application window corresponding to the position information belongs to a window of the second application in the second operating system, and that a drag release operation by the user on the target object is received, controlling the first application to send drag data of the target object to the second application; and
performing, based on the drag data, a target operation on the target object in the second application,
wherein the second operating system runs in the first operating system in a containerized mode.

2. The method of claim 1, wherein the performing, based on the drag data, the target operation on the target object in the second application comprises:
controlling the second application to obtain the target object based on the drag data; and
performing the target operation on the target object in the second application.

3. The method of claim 1, wherein the performing, based on the drag data, the target operation on the target object in the second application comprises:
controlling the second application to perform, based on a content of the target object comprised in the drag data, the target operation on the target object in the second application.

4. The method of claim 2, after performing the target operation on the target object, further comprising:
presenting a target icon in a window corresponding to the second application based on a window identifier of the second application comprised in the drag data, the target icon being generated based on the drag data.

5. The method of claim 2, wherein the controlling the second application to obtain the target object based on the drag data comprises one or more of:
in accordance with a determination that the drag data comprises a storage path of the target object, controlling the second application to obtain the target object based on the storage path;
in accordance with a determination that the drag data comprises an access identifier of a shared memory occupied by the target object, controlling the second application to obtain the target object from the shared memory based on the access identifier; or
in accordance with a determination that the drag data comprises a file descriptor of the target object, controlling the second application to obtain the target object based on the file descriptor.

6. The method of claim 1, wherein the first operating system comprises a first window manager and the second operating system comprises a second window manager, further comprising:
establishing a connection between the first window manager and the second window manager,
wherein the controlling the first application to send drag data of the target object to the second application comprises:
controlling the first window manager to send the drag data to the second window manager, and
controlling the second window manager to send the drag data to the second application based on a window identifier comprised in the drag data.

7. The method of claim 1, wherein the first operating system comprises a first window manager and a first service proxy component, and the second operating system comprises a second window manager and a second service proxy component, further comprising:
establishing a connection between the first service proxy component and the second service proxy component,
wherein the controlling the first application to send drag data of the target object to the second application comprises:
controlling the first window manager to send the drag data to the first service proxy component,
controlling the first service proxy component to send the drag data to the second service proxy component,
controlling the second service proxy component to send the drag data to the second window manager, and
controlling the second window manager to send the drag data to the second application based on a window identifier comprised in the drag data.

8. The method of claim 2, further comprising:
in accordance with a determination that a content of the target object is carried by a memory copy, before obtaining the target object, reading the content of the target object into a memory.

9. The method of claim 4, wherein the drag data further comprises position information of an icon of the target object in the window corresponding to the second application, and the presenting a target icon in a window corresponding to the second application based on a window identifier of the second application contained in the drag data comprises:
determining the second application corresponding to the window identifier; and
presenting the target icon in the window corresponding to the second application based on the position information of the target object in the window corresponding to the second application.

10. The method of claim 1, wherein before the controlling the first application to send drag data of the target object to the second application, the method further comprising:
determining, based on a window state of the second application, whether the window of the second application is in an active state; and
in accordance with a determination that the window of the second application is in the active state, performing an operation of controlling the first application to send the drag data of the target object to the second application.

11. The method of claim 1, further comprising:
in response to the drag operation by the user on the target object in the first application, presenting a drag effect view,
wherein the drag effect view comprises at least one of a highlight effect, a shadow effect, a blur effect, and an overlap effect for the target object.

12. The method of claim 6, wherein before a drag release operation by the user on the target object is received, the method further comprising:
controlling the first window manager to send a drag request to the second window manager; the drag request comprising metadata of the target object and a window identifier of the second application of the second operating system,
wherein the performing, based on the drag data, the target operation on the target object in the second application comprises:
determining whether the target object matches the second application based on the metadata of the target object, and
in accordance with a determination that the target object matches the second application, performing the target operation on the target object in the second application based on the drag data.

13. An electronic device comprising a memory, a processor, and a computer program that is stored on the memory and executable on the processor, the computer program, when executed by the processor, causes the electronic device to perform operations comprising:
establishing, at the electronic device with a first operating system and a second operating system running, a connection between the first operating system and the second operating system, wherein the first operating system comprises a first application, and the second operating system comprises a second application;
in response to a drag operation by a user on a target object in the first application, obtaining position information corresponding to the drag operation;
in accordance with a determination that an application window corresponding to the position information belongs to a window of the second application in the second operating system, and that a drag release operation by the user on the target object is received, controlling the first application to send drag data of the target object to the second application; and
performing, based on the drag data, a target operation on the target object in the second application,
wherein the second operating system runs in the first operating system in a containerized mode.

14. The electronic device of claim 13, wherein the performing, based on the drag data, the target operation on the target object in the second application comprises:
controlling the second application to obtain the target object based on the drag data; and
performing the target operation on the target object in the second application.

15. The electronic device of claim 13, wherein the performing, based on the drag data, the target operation on the target object in the second application comprises:
controlling the second application to perform, based on a content of the target object comprised in the drag data, the target operation on the target object in the second application.

16. The electronic device of claim 15, after performing the target operation on the target object, further comprising:
presenting a target icon in a window corresponding to the second application based on a window identifier of the second application comprised in the drag data, the target icon being generated based on the drag data.

17. The electronic device of claim 15, wherein the controlling the second application to obtain the target object based on the drag data comprises one or more of:
in accordance with a determination that the drag data comprises a storage path of the target object, controlling the second application to obtain the target object based on the storage path;
in accordance with a determination that the drag data comprises an access identifier of a shared memory occupied by the target object, controlling the second application to obtain the target object from the shared memory based on the access identifier; or
in accordance with a determination that the drag data comprises a file descriptor of the target object, controlling the second application to obtain the target object based on the file descriptor.

18. The electronic device of claim 13, wherein the first operating system comprises a first window manager and the second operating system comprises a second window manager, and the operations further comprise:
establishing a connection between the first window manager and the second window manager,
wherein the controlling the first application to send drag data of the target object to the second application comprises:
controlling the first window manager to send the drag data to the second window manager, and
controlling the second window manager to send the drag data to the second application based on a window identifier comprised in the drag data.

19. The electronic device of claim 13, wherein the first operating system comprises a first window manager and a first service proxy component, and the second operating system comprises a second window manager and a second service proxy component, and the operations:
establishing a connection between the first service proxy component and the second service proxy component,
wherein the controlling the first application to send drag data of the target object to the second application comprises:
controlling the first window manager to send the drag data to the first service proxy component,
controlling the first service proxy component to send the drag data to the second service proxy component,
controlling the second service proxy component to send the drag data to the second window manager, and
controlling the second window manager to send the drag data to the second application based on a window identifier comprised in the drag data.

20. A non-transitory computer readable storage medium having a computer program stored thereon, the computer program, when executed by a processor, cause an electronic device to perform operations comprising:
establishing, at the electronic device with a first operating system and a second operating system running, a connection between the first operating system and the second operating system, wherein the first operating system comprises a first application, and the second operating system comprises a second application;
in response to a drag operation by a user on a target object in the first application, obtaining position information corresponding to the drag operation;
in accordance with a determination that an application window corresponding to the position information belongs to a window of the second application in the second operating system, and that a drag release operation by the user on the target object is received, controlling the first application to send drag data of the target object to the second application; and
performing, based on the drag data, a target operation on the target object in the second application,
wherein the second operating system runs in the first operating system in a containerized mode.
